(19) United States
(12) Patent Application Publication
(10) Pub. No.: US 2019/0259384 A1
(43) Pub. Date: Aug. 22, 2019

(54) SYSTEMS AND METHODS FOR UNIVERSAL ALWAYS-ON MULTIMODAL IDENTIFICATION OF PEOPLE AND THINGS

(71) Applicant: INVII.AI, Mountain View, CA (US)

(72) Inventor: Sudhir Kumar SINGH, Mountain View, CA (US)

(73) Assignee: INVII.AI, Mountain View, CA (US)

(21) Appl. No.: 16/279,913

(22) Filed: Feb. 19, 2019

Related U.S. Application Data
(60) Provisional application No. 62/631,958, filed on Feb. 19, 2018.

(51) Int. Cl. G10L 15/22; G10L 17/00; G06N 3/02; G06K 9/00

(52) U.S. Cl. CPC G10L 15/22; G10L 17/00; G10L 2015/225; G06K 9/00288; G06N 3/02

(57) ABSTRACT

Methods and systems for building a universal always-on multimodal identification system. A universal representation to be used for executing one or more tasks, working on data with one or more signal modalities and comprising modal fusions signals at various levels is learned from a dataset that is targeted user or object agnostic. This universal representation is combined with a second stage task specific representation that is learned on-the-device using data from the particular user without sending the data to the cloud. The universal representation in combination with the downstream task specific representation is used to build a system to identify people and things using their visual appearances as well as voice by combining scores from one, two or more of the tasks such as face recognition and text independent voice recognition, wherein all required computation for the identification is performed completely on-the-device and no raw data from the user is sent to the cloud without explicit permission of an authorized user.

### CROSS-REFERENCE TO RELATED APPLICATIONS

This application claims priority to and the benefit of U.S. Provisional Patent Application No. 62/631,958, entitled “Universal Always-On Multimodal Identification of People and Things” and filed Feb. 19, 2018, the entirety of which is hereby incorporated by reference.

### FIELD OF THE INVENTION

The present invention is related to systems and methods for identifying users on a client device without sending data to the cloud.

### BACKGROUND

Smart assistant devices or apps both at a personal level (e.g. via a smartphone) as well as in the home (e.g. Alexa, Google Home, Apple Homepod) have become very popular recently. However, they are not truly intelligent in the sense that they fail to even understand who is actually communicating with them vs whose device/assistant they are. For example, a child might be playing on a parent's device and be exposed to inappropriate content as the device does not distinguish who the speaker or the person is, and might be thinking it is the parent who is actually using it. Further, more complex scenarios such as smart homes or personal robots that would interact with multiple users are currently still in-the-loop systems mostly taking one-off commands, such as, “Alexa switch off the thermostat”, or answering a question, such as “Ok Google, how far is the moon”. These devices completely disregard who they are interacting with. Further, in more practical multi-turn continuous interaction paradigm, such identification of people and things in an always ON manner becomes inevitable. Furthermore, this always ON processing of raw data calls for privacy preservation and on-device computation specially for younger users (e.g. children) that current solutions completely ignore.

The above-mentioned functionalities that are required for enabling novel consumer services while preserving privacy are difficult to implement with current technology for some of the following reasons.

1. Current Algorithms are Data Hungry and require Long Training Times: The main engine powering the current AI revolution is the framework of Deep Learning (DL). The framework of DL has made it feasible to accomplish important perceptual tasks with high-enough accuracy for products to be built around such tasks. Automatic Speech Recognition (ASR) is one such task, and products such as Alexa make use of this core DL-based technology. Object detection and face recognition are examples of some other tasks that have now been incorporated in a variety of products. To accomplish these tasks, large data sets are gathered and Deep Neural Networks (DNNs) are trained on thousands of GPU units in a central location. Later, these trained DNNs are deployed in applications where new data is processed to generate results. The requirements of the types of services that this patent targets do not directly fit into this general framework. First, the person whose identity is to be learned is by definition not part of the training set that was used to train the DNN. This is a new person whose voice and body and face need to be learned. Incremental learning is a challenge for the current DNN framework. Second, identity needs to be established quickly with only a few samples. Again this is a challenge for current DL systems as it needs a lot of data to learn new objects and categories. Third, the accuracy of the trained DNNs are directly dependent on the quality and diversity of data used to train them. For example, most speech-to-text/word systems are trained using data from adults and they do not do well on kids' voice. Alexa for example has a difficult time understanding commands from young boys and girls. In the types of applications this invention is aimed at enabling, the environment will have people with a wide variety of age and speech patterns, and there will be also echo and multi-path interference. One needs adaptive and agile learning algorithms that would be able to learn new identities with very few samples.

2. The DNNs are power and computation intensive: Even the inference engine part, where the DNNs are already trained and new data needs to be simply processed for inference purposes, is computation and power intensive. The types of devices, such as smart phones and mobile robotic companions, neither have enough computing resources nor enough battery power to be able to execute recognition and other perceptual tasks in real-time over an extended period of time. Any traditional learning algorithms will be even more demanding on any such edge-computing hardware. This again underscores the need for the system being introduced by this invention that can work with light touch on both hardware and software complexity while providing new services.

3. The existing paradigms for entity recognition and tracking are mostly Unimodal: As humans, we create memory of an individual based on multiple signals, including visual imagery, voice and speech patterns, smell etc. The current systems for creating identities of different individuals are mostly based on single types of signals, for example face recognition based on images, or voice recognition based on aural signals. A multimodal systems, as proposed in this invention, however, have several advantages: (a) robustness and higher precision: By combining images, speech, gait, sound and vibrational signatures from movements such as walking and running, etc., one can make a much more confident decision about the identity of an individual, especially when none of the signals is strong. This is a common practice used by animals and humans. (b) Incremental multi-modal identity learning: For example, when the system learns a new identity based on aural signals, next time when it has a video feed and it can attribute speech to images, then it can automatically create a face and body/gait based visual recognition signature for the individual. Similarly, when it records sounds/vibrations of different signatures from people walking around in the house, it can then attribute these different signatures to one persistent and integrated identity. Each person or pet in a household is represented by a multi-modal and persistent signature. Thus, correlated and multimodal identities for individuals and objects get created in an automated fashion. The system can do predictive perception: If it hears a voice coming from another room, and the foot steps are getting louder, then it would know who to expect and what visual signal would show up at which door of the room that the device is in. This helps not only in more accurate recognition, but also can enable the system to for example warn a child if there are any unexpected hazards in his path or proactively help the person find something that he might have forgotten or misplaced in the room.

4. Privacy Protection and On-Device Computing: One of the primary goals of the invention is privacy protection. This is ensured by making certain that no data about the end users gets uploaded on the cloud without explicit permission from the users. Thus, unlike most applications where personal data, comprising images, videos and speech, gets uploaded on powerful servers which perform the bulk of the computing and analysis work. However, in our invention the data is analyzed locally on a personal device hardware platform which again is both compute and power limited. This again necessitates the types of software-hardware system designed in this invention.

### SUMMARY

Embodiments of the invention are directed to methods and systems for building a universal always-on multimodal identification system as well as the multimodal identification system. A universal representation with one or more signal modalities with one or more tasks with modal fusions at various levels is learned from a dataset agnostic to a targeted user, and is combined with a second stage task specific representation that is learned on-the-device using data from the particular user, without sending the data to the cloud. The universal representation in combination with the downstream task specific representation is used to build a system to identify people and things using their visual appearances as well as voice by combining scores from one, two, or more of the tasks, such as face recognition, text independent voice recognition, text dependent voice recognition and others, wherein all of the computation needed to perform the identification is completely on the device and no raw data from the user is sent to the cloud without explicit permission of the user.

In accordance with one aspect of the invention, a system for universal always-on multimodal identification of people and things is disclosed that includes a universal multimodal signal representation extraction module that computes a reduced dimensional representation of signals as a universal representation; a set of task specific representation extraction modules that use the universal representations of the signals and also computes task-specific representations of the signals, wherein the task-specific representations have discriminative information for specific tasks; and a set of perceptual task execution modules that create multimodal and persistent identities of people and things based on multimodal signals and using both the universal representation and the task-specific representations.

The signals may include one or more selected from the group consisting of videos, images, speech, and sounds.

The universal multimodal signal representation extraction module may compute multimodal universal representations from a fixed set of training data that does not include training samples from the people and things whose identities are to be determined. The universal representation may be computed by using deep neural networks. The universal representation may be computed using a hierarchical set of graphical models that represent signals from a finer to more granular set of patterns. The universal representations may be computed by combining different modalities of signals at an early stage and then processing the combined signals through multiple stages to extract multi-level representations. The universal multimodal representation may be computed by processing different modalities of signals separately through multiple stages, and then fusing the processed signals to obtain a final representation. The universal representation extraction module may be trained using multimodal signals under different loss functions and then a final representation is obtained by taking a weighted sum of the different loss function representations. The loss functions may be selected from the group consisting of cross entropy, L2, and L1. The training of the universal representation extraction module may be carried out separately on servers, wherein the trained module is provided to a personal device associated with the people or things for task specific computations.

The task specific representations may be computed for people, and the tasks may be selected from the group consisting of face recognition, voice recognition with and without text, age estimation, gender estimation, gait recognition, foot-step recognition, and running pattern recognition. The task specific representations may be computed for animals, and the tasks may be selected from the group consisting of dog and cat breed recognition, bark and call recognition of the animals, age and gender estimation of the animals, gait recognition, foot-step recognition, running pattern recognition, categories and brand recognition of different objects associated with the animals. The task specific representations may be computed by using universal representations as inputs along with other representations computed from new data obtained during a task execution phase.

Classifiers and estimators for the different tasks may be learned jointly by combining loss functions for different tasks. The classifiers and estimators for different tasks may be learned separately.

No user or object specific data may be uploaded to the cloud and the multimodal identifications are learned and stored in the user device.

In accordance with another aspect of the invention, a system for universal always-on multimodal identification of people and things is disclosed that includes a network interface; memory; a camera for capturing image data from one of the people and things; a microphone for capturing audio data from one of the people and things; and a processor, wherein the processor receives task-specific representation models for identifying the people and things via the network interface and stores the task-specific representation models in the memory and wherein the processor determines an identity of the one of the people and things using at least one of the captured image data and captured audio data and using the task-specific representation models without sending the captured image data or audio data over the network interface.

The processor may include a classifier for determining the identity of the one of the people and things using at least one of the captured image data and captured audio data and using the universal representation model and task-specific representation models. The processor may determine the identity of the one of the people and things using both the captured image data and the captured audio data. The system may further include a plurality of sensors for capturing data about the one of the people and things, and wherein the processor determines the identity of the one of the people and things using the captured data from the plurality of sensors.

### BRIEF DESCRIPTION OF THE DRAWINGS

There are shown in these drawings the embodiments which are presently preferred. It is expressly noted however that the invention is not limited to the precise arrangements, scenarios, and instrumentalities shown.

FIG. 1 is a block diagram of a network for implementing embodiments of the invention.

FIGS. 2A and 2B are block diagrams illustrating exemplary systems for implementing embodiments of the invention.

FIG. 3 illustrates example elements of an identification system in accordance with embodiments of the invention.

FIG. 4 illustrates an example of aural representation via 8 layer deep convolutional neural networks in accordance with one embodiment of the invention.

FIG. 5 illustrates an example of visual representation via 8 layer deep convolutional neural networks in accordance with one embodiment of the invention.

FIG. 6 illustrates an example of visual representation via 5 layer deep convolutional neural networks in accordance with one embodiment of the invention.

FIG. 7 illustrates a flow diagram for a process of identifying a representation model in accordance with embodiments of the invention.

FIG. 8 illustrates a flow diagram for a process of determining an identity of a person or object in accordance with embodiments of the invention.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

Methods and systems for building a universal always-on multimodal identification system is disclosed.

According to one embodiment, a universal representation with one or more signal modalities with one or more tasks with modal fusions at various levels is learned from a dataset agnostic to a targeted user, and is combined with a second stage task specific representation that is learned on-the-device using data from the particular user without sending the data to the cloud. In another embodiment, the universal representation in combination with the downstream task specific representation is used to build a system to identify people and things using their visual appearances as well as voice by combining scores from one, two or more of the tasks such as face recognition and text independent voice recognition, wherein all required computation for the identification is performed completely on-the-device and no raw data from the user is sent to the cloud without explicit permission of an authorized user.

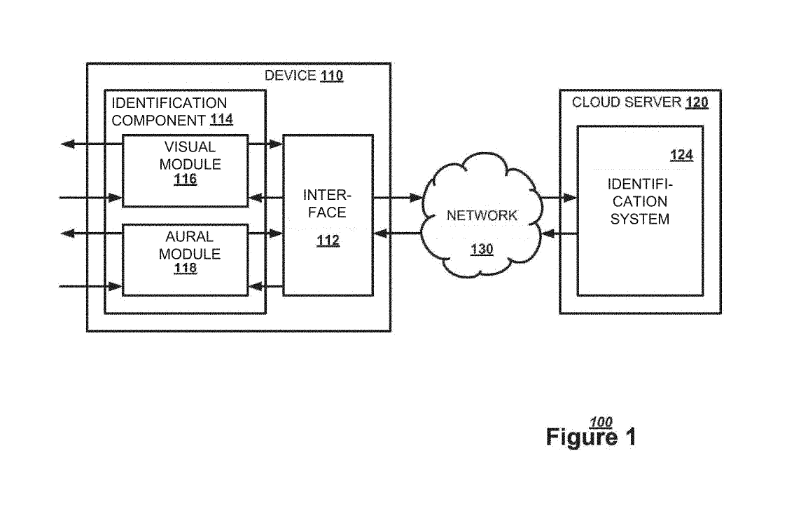

FIG. 1 illustrates, in a block diagram, one embodiment of an identification system 100. A user device 110 may connect to a cloud server 120 via a network 130. The network 130 may be through the internet or over a mobile data network. As shown in FIG. 1, the cloud server 120 includes an identification system 124 that includes a learning model 128. The learning model 128 performs universal representation and task-specific representation to build a representation that is used to identify users without sending data from the users over the network 130. The user device 110 includes an interface 112 for accessing the network 130. The user device also includes an identification component 114 including a visual recognition module 116 and a voice recognition module 118. As discussed in further detail herein, the identification component 114 is able to perform an identification of an authorized user using face recognition performed in the visual recognition module 116 and/or using text independent voice recognition using the voice recognition module 118 based on the representation generated by the cloud server 120 and task specific representations performed by the identification component 114.

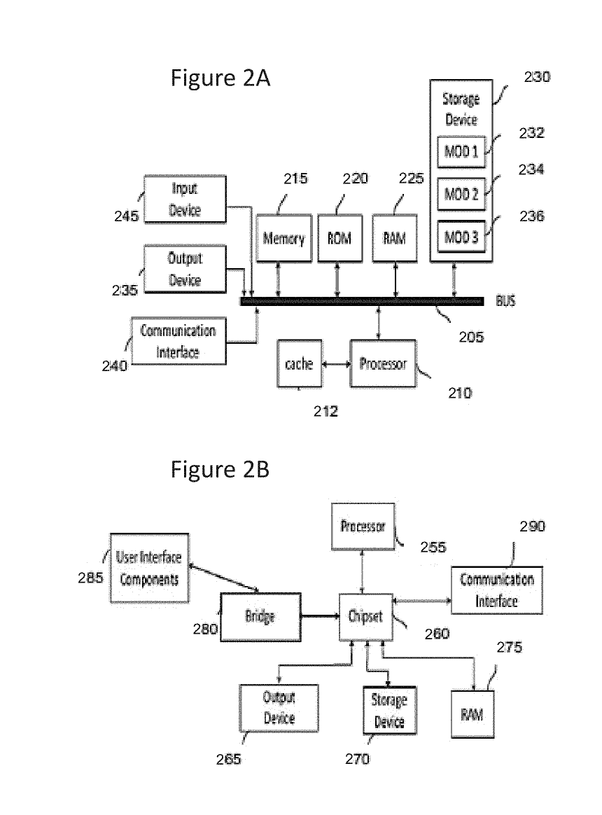

FIGS. 2A and 2B illustrate exemplary possible device configurations corresponding to device 110. The more appropriate configuration will be apparent to those of ordinary skill in the art when practicing the present technology. Persons of ordinary skill in the art will also readily appreciate that other system configurations are possible.

FIG. 2A illustrates a conventional system bus computing system architecture 200 wherein the components of the system are in electrical communication with each other using a bus 205. Exemplary system 200 includes a processing unit (CPU or processor) 210 and a system bus 205 that couples various system components including the system memory 215, such as read only memory (ROM) 220 and random access memory (RAM) 225, to the processor 210. The system 200 can include a cache of high-speed memory connected directly with, in close proximity to, or integrated as part of the processor 210. The system 200 can copy data from the memory 215 and/or the storage device 230 to the cache 212 for quick access by the processor 210. In this way, the cache can provide a performance boost that avoids processor 210 delays while waiting for data. These and other modules can control or be configured to control the processor 210 to perform various actions. Other system memory 215 may be available for use as well. The memory 215 can include multiple different types of memory with different performance characteristics. The processor 210 can include any general purpose processor and a hardware module or software module, such as module 1 232, module 2 234, and module 3 236 stored in storage device 230, configured to control the processor 210 as well as a special-purpose processor where software instructions are incorporated into the actual processor design. The processor 210 may essentially be a completely self-contained computing system, containing multiple cores or processors, a bus, memory controller, cache, etc. A multi-core processor may be symmetric or asymmetric.

To enable user interaction with the computing device 200, an input device 245 can represent any number of input mechanisms, such as a microphone for speech, a touch-sensitive screen for gesture or graphical input, keyboard, mouse, motion input, speech and so forth. An output device 235 can also be one or more of a number of output mechanisms known to those of skill in the art. In some instances, multimodal systems can enable a user to provide multiple types of input to communicate with the computing device 200. The communications interface 240 can generally govern and manage the user input and system output. There is no restriction on operating on any particular hardware arrangement and therefore the basic features here may easily be substituted for improved hardware or firmware arrangements as they are developed.

Storage device 230 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 225, read only memory (ROM) 220, and hybrids thereof.

The storage device 230 can include software modules 232, 234, 236 for controlling the processor 210. Other hardware or software modules are contemplated. The storage device 230 can be connected to the system bus 205. In one aspect, a hardware module that performs a particular function can include the software component stored in a computer-readable medium in connection with the necessary hardware components, such as the processor 210, bus 205, display 235, and so forth, to carry out the function.

FIG. 2B illustrates a computer system 250 having a chipset architecture that can be used in executing the described method and generating and displaying a graphical user interface (GUI). Computer system 250 is an example of computer hardware, software, and firmware that can be used to implement the disclosed technology. System 250 can include a processor 255, representative of any number of physically and/or logically distinct resources capable of executing software, firmware, and hardware configured to perform identified computations. Processor 255 can communicate with a chipset 260 that can control input to and output from processor 255. In this example, chipset 260 outputs information to output 265, such as a display, and can read and write information to storage device 270, which can include magnetic media, and solid state media, for example. Chipset 260 can also read data from and write data to RAM 275. A bridge 280 for interfacing with a variety of user interface components 285 can be provided for interfacing with chipset 260. Such user interface components 285 can include a keyboard, a microphone, touch detection and processing circuitry, a pointing device, such as a mouse, and so on. In general, inputs to system 250 can come from any of a variety of sources, machine generated and/or human generated.

Chipset 260 can also interface with one or more communication interfaces 290 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 255 analyzing data stored in storage 270 or 275. Further, the machine can receive inputs from a user via user interface components 285 and execute appropriate functions, such as browsing functions by interpreting these inputs using processor 255.

It can be appreciated that exemplary systems 200 and 250 can have more than one processor 210 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some configurations the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

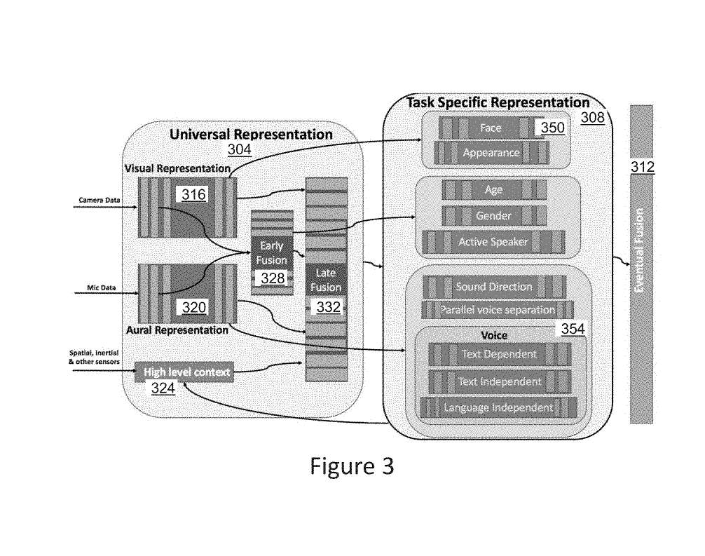

As shown in FIG. 3, an identification system 300 is disclosed that includes a universal representation module 304 and a task specific representation module 308. As described in further detail below, the universal representation module 304 performs universal representation and the task specific representation module 308 performs task specific representation. The universal representation module 304 is in communication with the task specific representation module 308. The identification system 300 further includes a fusion module 312. In FIG. 3, the fusion module 312 is illustrated as being in communication with the task specific representation module 308. It will be appreciated that the modules 304, 308 and 312 may differ from that illustrated in FIG. 3. It will further be appreciated that the modules 304, 308 and 312 may each be a processor, a combination of processor and memory, and/or the modules 304, 308, 312 may share processors and/or memory. It will be further understood that the identification system 300 may implemented on a single computer, server or a combination of computers/servers.

Universal Representation:

The universal representation module 304 will now be discussed in further detail. The universal representation module 304 includes a visual representation module 316 and an aural representation module 320. The visual representation module 316 receives and processes camera data (e.g., images, videos, etc.) and the aural representation module 320 receives and processes audio data (e.g., from a microphone). The universal representation module 304 may also include a high level context module 324 that receives and processes data from spatial, inertial and other sensors.

Given a set of signal/data modes such as images, videos, and audios and a set of classification or detection tasks such as face recognition, voice recognition, and active speaker recognition, a universal representation of a multimodal signal means a set of computationally implementable mathematical models (e.g. deep neural networks, and/or multilayered graphical models) that can output a fixed dimensional representation of the input suited for all of those tasks in combination with or without a follow up model specific to one or more of those tasks. Thus, the universal representation module 304 generates a set of salient intermediate representations, that can be used to perform specific tasks in the following stages.

The mathematical models that compute the universal representation are usually deep in the sense that there are various levels of abstractions of knowledge (derived from the input signals) leading to the representation. For example, in one embodiment, there are five consecutive convolutional neural network blocks followed by two fully connected neural network blocks that when trained on a lot of images using stochastic gradient descent lead to various levels of visual abstractions such as edges and corners, colors, object parts, and eventually various views of those objects. Similarly, in another embodiment, a set of hierarchical graphical models where each layer builds on similarity clustering of the previous layer according to a suitable metric, leads to the same set of visual knowledge at various levels.

The learning of the models (for example DNNs or deep graphical models) for computing universal representations can be done off-line in dedicated and high-powered devices, and powered by a sufficiently large amount of data. The data needed to compute represents the “experience” the system needs to have in order to efficiently and accurately perform the specific tasks. The more the number of distinct tasks and signal modalities the universal representation handles, the more complex the representation is, and consequently the more data required to learn from. However, if the specific tasks share similar characteristics at low level of representations, the representation trained for one of the tasks with a lot of data, and just a little data for a second task, will still give a very good result for the second task. For example, face recognition algorithms trained to recognize faces for adults can also contribute towards computing good universal representation of face images of children. The resultant universal representation (learned from processing only adult faces) as determined by the universal representation module 304 generates representations that can be used to design an accurate face recognizer for children even with fewer number of samples. The learning phase can be thus done efficiently (from both computational resources and the number of samples) on the device itself. In another example, a representation learned from recognition of a general set of objects can facilitate the task of recognizing various breeds of dogs with comparatively less amount of data on the dogs. This is very much like what happens in the human brain, wherein various levels of abstractions are learned as we explore the world and then we learn to recognize new things pretty quickly given only a few data points, based on the universal representations learned already.

When there are more than one data/signal modes (e.g. images and audio), the fusion of the knowledge from various modalities can be performed at various levels in one or more fusion modules 328, 332. The raw data itself (or after a simple preprocessing) can be combined together and sent through a set of operations. This is a signal level fusion (not shown). Alternatively, the signals can be sent through a fairly complex set of operations specific to the signal mode, then combined and sent through a set of operations, and there is usually further operation downstream specific to the respective signal mode as well. This is called early fusion of modalities (performed by the early fusion module 328). In yet another scenario, the signals are sent through a fairly complex set of operations specific to the signal mode, then combined only at the end, and there is no further operation downstream specific to the individual signal modes. This is called late fusion of modalities (performed by the late fusion module 332).

The universal representation in this disclosure includes each of these types of fusions and is illustrated in FIG. 3. In one embodiment, there are two modes, namely images from the camera and audio from the microphone (“mic”), and the tasks are to identify a person based on face as well as person's voice.

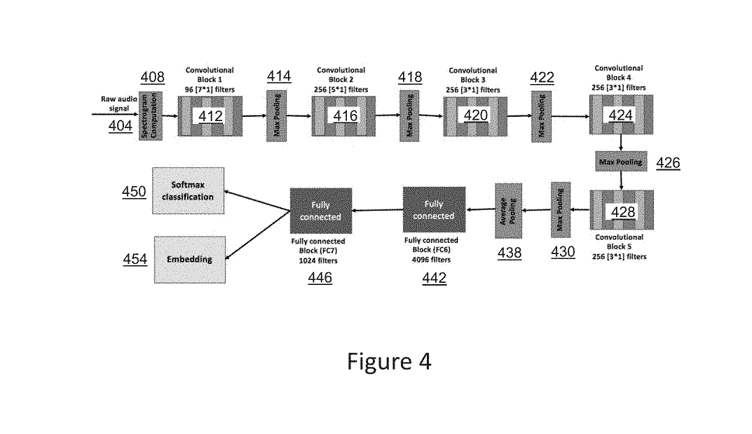

A detailed illustration of the aural representation module 320 is shown in FIG. 4. The voice/aural representation part of the model is another deep convolutional neural network depicted in FIG. 4. As shown in FIG. 4, the raw audio signal 404 undergoes a spectrogram computation 408. The data is then processed by a series of convolutional blocks (412, 416, 420, 424, 428) separated by max pooling steps (414, 418, 422, 426, 430). The data then undergoes average pooling 438 before it is fully connected by two separate fully connected blocks 442, 446. As shown in FIG. 4, the fully connected blocks 442, 446 are different—one has 4,096 filters and the other has 1,024 filters. The data then undergoes softmax classification 450 and embedding 454.

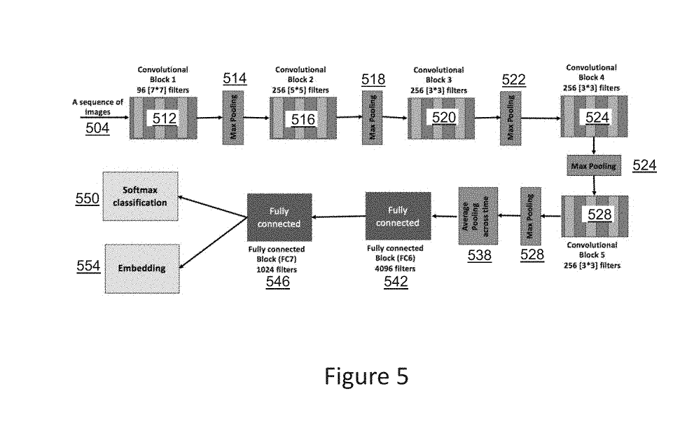

A detailed illustration of the visual representation module 316 is shown in FIG. 5. The visual representation part of the model is a deep convolutional neural network depicted in FIG. 5. As shown in FIG. 5, the sequence of images 504 is processed by a series of convolutional blocks (512, 516, 520, 524, 528) separated by max pooling steps (514, 518, 522, 526, 530). The data then undergoes average pooling across time 538 before it is fully connected by two separate fully connected blocks 542, 546. As shown in FIG. 5, the fully connected blocks 542, 546 are different—one has 4,096 filters and the other has 1,024 filters. The data then undergoes softmax classification 550 and embedding 554.

The early fusion module 328 may also perform a set of neural network operations applied on combination of one or more of early convolutional blocks of the visual and aural representations.

The late fusion module 332 may include several fully connected layers and recurrent neural networks.

### Task Specific Representation:

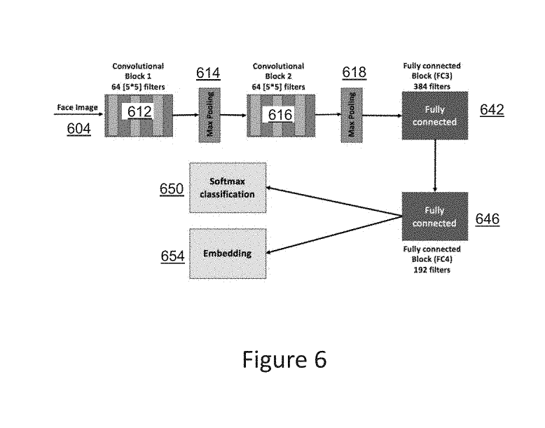

Referring back to FIG. 3, the task representation module 308 will now be described in further detail. The task representation module 308 generates task specific representations of the data. A task specific representation means a set of computationally implementable mathematical models (e.g. deep neural networks or support vector machines) which is solely meant for that specific task. For example, a five layer deep convolutional neural network learnt specifically for face recognition, as shown in FIG. 6. In FIG. 6, the face image data 604 is processed by a series of convolutional blocks (612, 616) separated by max pooling steps (614, 618). The data is then fully connected by two separate fully connected blocks 642, 646. As shown in FIG. 6, the fully connected blocks 642, 646 are different—one has 384 filters and the other has 192 filters. The data then undergoes softmax classification 650 and embedding 654. This face recognition specific representation would in general not work well for other more complex visual recognition tasks such as object recognition. Although, this representation is specific to a task it may involve more than one modality. For example, a representation specific to the task of identifying the speaker who is talking in a video can exploit two modes—voice as well as lip movement. These task-specific models will typically process the signals through relevant universal representation computing modules (which have already been trained off-line) and use these representations as inputs.

Task specific representation is relatively shallow compared to a universal representation and when used in combination with a universal representation is very sample efficient, meaning that it requires much less additional data to train. Moreover, since the network structure is small in size, it can be easily computed and learned on the user device. In one embodiment, it is two layers of fully connected neural networks learned via stochastic gradient descent. In another embodiment, it is a support vector machine either learned via convex optimization or stochastic gradient descent via its representation as a fully connected layer without non-linear activation along with L2 regularization.

Some examples of specific tasks that are exploited for identification of people and things are—face recognition using images, age and gender detection using images and audio, appearance based person recognition using images, as well as voice recognition using audio either in text dependent or independent manner. There are also tasks like speaker change detection using both audio and images. Other tasks could be characterizing foot steps and running patterns of different individuals through vibration and microphone signals, and building identities of different individuals based on such signals.

From a point of view of efficient implementation, these relatively shallow representations are very efficient in term of computation and ensure preservation of the privacy of the user via processing all raw data on-the-device 110, and not sending any data to the network 130 without explicit permission of the authorized users.

Another benefit of a task specific representation due to its shallow nature is its spontaneous training. For example, in case of voice recognition, the enrollment can happen pretty quickly in as fast as seconds or minutes instead of hours and days of training.

### Learning Universal Representations:

As discussed above, the universal representations are usually complex, and involve deep architectures such as several layers of neural networks or hierarchical graph structures. Without much prior knowledge on the structure or geometry of solution space encompassing a multitude of tasks, which is usually the case in practice, training such models requires a huge amount of relevant data as well as compute power. This training can be done off-line on powerful servers.

In one embodiment Stochastic gradient descent (SGD) algorithm is used with a variety of loss functions obtained by combining the task specific loss functions for each task. A Loss Function measures how closely the output of the model can approximate the desired output in the training data. Also, the models can either be trained one by one with respect to these various loss functions or in one go just with a combined loss function. Further, other optimization methods such as coordinate descent or interior point methods can be used instead to minimize the loss function.

In one embodiment, a combined loss function is obtained by a linear combination with equal weight of the individual loss functions with respect to each involved task and the whole network is trained with respect to this cost/loss function. For example, for the model in FIG. 3, the cost is a sum of the ten softmax cross entropy costs, one each for each of the ten tasks (e.g. Face, appearance, age, gender, active speaker, sound direction, parallel voice, text dependent voice, text independent voice, and language independent voice).

In another embodiment, two turns are taken and repeated, one for each mode of the signal. In turn one, all parts of the model are frozen, except the Visual Representation part, which is updated with respect to a cost function that combines the softmax entropy costs just from the visual tasks (e.g. Face, Appearance, Age, Gender and active speaker). In the second turn, all parts of the model are frozen except the Aural Representation part, which is updated with respect to a cost function that combines the softmax entropy costs just from the audio tasks (e.g. Sound direction, parallel voice, text dependent voice, text independent voice, and language independent voice, Age, Gender and active speaker). Each of the turn is run for a sufficiently long number of SGD/optimization steps before moving to the next turn. The whole procedure is repeated for a sufficiently long number of steps alternating between the two turns until the loss value becomes smaller than a predefined tolerance value close to zero. During this training all the data points are revisited several times and high-level learning parameters (such as learning rate in SGD) can be tuned based on performance of the learned model on a set-aside part of the dataset.

In yet another embodiment, instead of just two turns guided by modalities, there are ten turns one each for a specific task. In a given turn, the whole network (i.e. model parameters) is updated based on the optimization of the softmax cross entropy cost of that particular task. Each turn is run for sufficiently long time leading to sufficient reduction of the respective loss function. The whole procedure is repeated for a sufficiently long number of steps alternating between the ten turns until the loss value becomes too small, a predefined value close to zero, for all the individual task specific loss functions.

### Learning Task Specific Representations:

The task specific representations are learned in two manners—one in conjunction with a universal representation and another in an end-to-end manner. In the end-to-end case, the learning is equivalent to a “turn” in learning a universal representation in the case where turns are based on individual tasks. Usually, depending on the complexity of the model, the data requirements are relatively higher compared to the case where the task specific representation is learned in conjunction with a universal representation.

Given a learned universal representation with one or more data modes, a task specific representation learning is performed as follows. First, all the raw data points are transformed as per mathematical model of the universal representation. Therefore, for each data point for training this task specific representation, the actual input are not the raw data points but the computed universal representation of the data points. For example, in training for the face recognition task, the actual data points as input to the training algorithm is the output of the deep neural network in FIG. 3 depicted the universal representation module 304 for every image in the training dataset for face recognition. With these transformed datasets, now the task specific models can be trained using either SGD or an alternative optimization method. The models are relatively shallower, such as only two fully connected layers of a neural network or a support vector machine, and are trained in significantly much smaller compute time.

In other embodiments, instead of the full-fledged universal representation, the task specific model can be trained with only a part of the universal representation instead. For example, in FIG. 3, the face recognition task specific SVM model 350 can be trained in conjunction with just the output of the visual representation module 316.

In one embodiment, a face recognition model is trained based on millions of face images of thousands of celebrities, the data that is available on the internet, and learn a universal representation. To learn new faces and recognize them, this representation in combination with a task specific SVM model that is learned with as few as five images per person is used. Further, this model can be trained as quickly as in a few seconds or minutes on an embedded computing device (e.g., device 110).

In another embodiment, a text independent language independent voice recognition model is trained based on millions of audio samples of thousands of celebrities, the data that is available on the internet, and learn a universal representation using the aural representation module 320. To learn voices and recognize them, this representation in combination with a task specific SVM model 354 that is learned with as few as 15 seconds of voice clips per person are used. Further, this model can be trained as quickly as in a few seconds or minutes on an embedded computing device.

### Automatic Data Collection and Model Evolution:

In a multi-modal multi task scenario such as the identification of people and things, the different modalities can not only enforce each other's confidence by their fusion at various levels (signal, early or late) but also enable training data collections for complementary modalities. For example, when a voice recognition model identifies a person with high confidence, but the face recognition model has much lower confidence, the face image input can be collected as new training data for the face recognition task. When enough of these new face images of that person are collected, the face recognition specific representation model can be retrained using this newly collected data. In a similar manner, when face recognition has a high confidence score, but voice recognition does not, new voice samples are collected and the voice recognition task specific representation can be retrained on the new data. In another embodiment, when both the algorithms give high confidence, data in both modalities can be collected as well. Therefore, new training data can be collected as more and more new examples are passed through various tasks, and subsequently the respective task specific models can be updated. When the training data becomes too large so that more complex models can be trained, the task specific representation can be an end-2-end model trained much like the universal representation. This alternative modality driven data collection and the evolution of the models based on the collected data is also a key aspect of our invention.

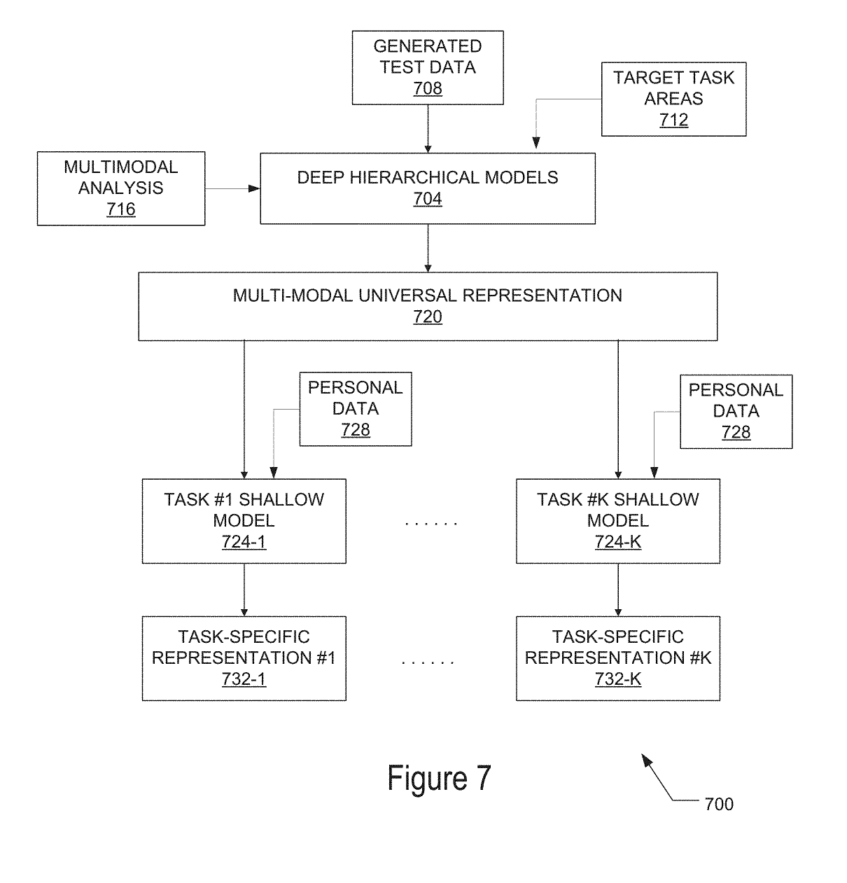

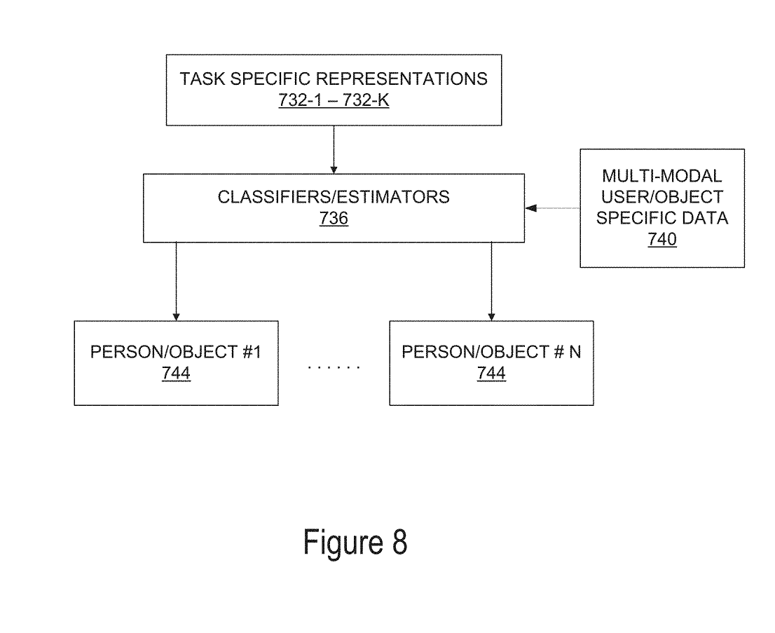

This process is illustrated in further detail in FIG. 7. As shown in FIG. 7, the process 700 begins with deep hierarchical models 704 generated from generated test data 708 and target task areas 712 using a multimodal analysis 716. The output of the deep hierarchical models 704 are multi-modal universal representations 720. The multi-modal universal representations 720 are provided to task-specific, shallow models 724-1-724-k. Personal data 728 is processed by the task-specific models 724 to generate task-specific representations 732-1-732-k. Then, as shown in FIG. 8, the task-specific representations 732-1-732-k are provided to classifiers or estimators 736 (e.g., on the user device 110). Based on multi-modal user or object-specific data 740 (e.g., visual/audio data from the user on the user device 110), the classifiers or estimators 736 are able to identify a person or object 744.

### Privacy Aware Always-ON Identification:

In practical multi-turn continuous interaction paradigm, wherein there are multiple users and things interacting back and forth, the identification of people and things in an always ON manner become inevitable. Also, this always ON processing of raw data calls for privacy preservation and on-device computation specially for younger users (e.g. children).

Our two stage representation and models—namely universal representation followed by a task specific representation—allows us to perform this effectively. In particular, the complex and heavy computation step of training universal representation is not required to be on-device and the training data for this can come from elsewhere and not necessarily this particular user. So this step is performed in a cloud computing infrastructure and no privacy is lost as training data does not come from this user. The inference step i.e. computing the learned universal representation given a new input, is also performed on the device, thus not sending this new data to the cloud keeping the user data private. This inference step can be further optimized using various quantization methods making computation light weight on the device. The step of training task specific representations are relatively light weight computations as the models are shallower and can be performed on the device. The training data for this purpose does come from the user but need not be sent to the cloud thus preserving the privacy. Finally, once this task specific model is learned, when a new input comes, first the universal representation for this is computed and then that representation is passed through computation of the task specific representation, and this second representation is then used to identify the user. All of the computation is performed on the device and no raw data is sent to the cloud. A user may choose to save some of this data as her memory or moments in the cloud but that process is completely explicit and under the user's control.

### Multimodal Identification of People and Things:

On top of the modules discussed above, a system is disclosed that can identify people and things using several signal/data modalities such as images and videos from a camera, and audio from the microphones. One embodiment of the invention is illustrated in FIG. 3. This is implemented in a three stage process.

In the first stage, a universal representation is learnt as described earlier in this document with the ten tasks as shown in FIG. 3 (face recognition through language independent voice recognition). This stage does not require any data from any particular user that may ultimately use the device and therefore may be same for all the users, and is performed in a cloud computing environment due to its complexity.

In the second stage, called enrollment, when the requirement to identify a new user is demanded, the system requests a few samples of the data (e.g. saying a few pre-determined or random sentences with face in the view of the system's camera). This step is a very sample efficient step as it requires only little data to get started (e.g. 5 face images, 15 seconds of audio or simply a 15 seconds of video). This enrollment data is used to train the task specific representations for one, more or all of the ten tasks as per the schemes described earlier in this disclosure. At the completion of this step, models and algorithms for performing each of these tasks are obtained. This stage is performed completely on the device and no raw data from the user is sent to the cloud. Further, this second stage can be repeated periodically (e.g. frequently for younger children) and the models get updated trained with new data, as specifically for children face and voice changes over time.

In the final stage, when a new data arrives from the user (e.g. just a voice or a video clip), the model for various tasks are run and their confidence scores are obtained. These scores are combined via an eventual fusion scheme that is a simple linear combination of the scores or a majority takes all scoring or another non-linear function. At the end of this step, the user is either identified as one of the registered users or as a stranger. In case of a stranger, the system asks for permission from a registered user to allow enrollment for this stranger. Note that, there are many chances to do the recognition for example starting every second of the audio or video. Higher level contexts, such as sentence structure or completion, are used to feed appropriate input to be identified. Further, all the computations involved in this stage are performed entirely on the device and no raw data from the user is sent to the cloud.

Note that this multimodal identification system applies not just to data coming from people but from things as well, or a combination of the two. For example, it can learn to identify various TV and movies characters and toys such as Peppa Pig, Elmo, Mickey, Buzz lightyear, bubble guppies, Elsa etc, using their appearance as well as voice.

### Key Applications:

The universal always-on multimodal identification system presented in this disclosure is crucial to any multiuser interaction experience and can be used for a variety of applications such as listed below but not limited to them:

A smart home or a family robot that interacts with several people

Secure access to a device without sending any raw data to the cloud

Selective listening i.e. listening only to the people who are active participants in an activity/conversations or by explicit instruction. For example, an adult (mom or dad) might ask a child's robot to not listen to them and the robot continues to listen and interact with the child but ignores any conversations that the adults might have.

Safe social network for kids, wherein the data is pushed to a particular user (e.g. the child) only if it comes from a person who is allowed to do so and this identification/authorization is performed by the universal multimodal identification system presented here. Further, the actual content of a media can also be analyzed and sent only if the right person is trying to access it.

A smart play center for kids where 21st century skills are emphasized and monitored, analyzed and progress created for caregivers and parents. The requirement for knowing who actually that child is built on the identification system invented in this disclosure.

The inventive system is also crucial in a single user interaction scenario where things with voices (e.g. toys & characters) are involved (e.g. a child playing with her toys).

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Claim language reciting “at least one of” a set indicates that one member of the set or multiple members of the set satisfy the claim. Tangible computer-readable storage media, computer-readable storage devices, or computer-readable memory devices, expressly exclude media such as transitory waves, energy, carrier signals, electromagnetic waves, and signals per se.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A system for universal always-on multimodal identification of people and things comprising:
a universal multimodal signal representation extraction module that computes a reduced dimensional representation of signals as a universal representation;
a set of task specific representation extraction modules that use the universal representations of the signals and also computes task-specific representations of the signals, wherein the task-specific representations have discriminative information for specific tasks;
a set of perceptual task execution modules that create multimodal and persistent identities of people and things based on multimodal signals and using both the universal representation and the task-specific representations.

2. The system of claim 1, wherein the signals comprise one or more selected from the group consisting of videos, images, speech, and sounds.

3. The system of claim 1, wherein universal multimodal signal representation extraction module computes multimodal universal representations from a fixed set of training data that does not include training samples from the people and things whose identities are to be determined.

4. The system of claim 1, wherein the universal representation is computed by using deep neural networks.

5. The system of claim 1, wherein the universal representation is computed using a hierarchical set of graphical models that represent signals from a finer to more granular set of patterns.

6. The system of claim 1, wherein the universal representations is computed by combining different modalities of signals at an early stage and then processing the combined signals through multiple stages to extract multi-level representations.

7. The system of claim 1, wherein the universal multimodal representation is computed by processing different modalities of signals separately through multiple stages, and then fusing the processed signals to obtain a final representation.

8. The system of claim 1, wherein the universal representation extraction module is trained using multimodal signals under different loss functions and then a final representation is obtained by taking a weighted sum of the different loss function representations.

9. The system of claim 8, wherein the loss functions are selected from the group consisting of cross entropy, L2, and L1.

10. The system of claim 1, wherein training of the universal representation extraction module is carried out separately on servers, wherein the trained module is provided to a personal device associated with the people or things for task specific computations.

11. The system of claim 1, wherein the task specific representations are computed for people, and wherein the tasks are selected from the group consisting of face recognition, voice recognition with and without text, age estimation, gender estimation, gait recognition, foot-step recognition, and running pattern recognition.

12. The system of claim 1, wherein the task specific representations are computed for animals, and wherein the tasks are selected from the group consisting of dog and cat breed recognition, bark and call recognition of the animals, age and gender estimation of the animals, gait recognition, foot-step recognition, running pattern recognition, categories and brand recognition of different objects associated with the animals.

13. The system of claim 1, wherein task specific representations are computed by using universal representations as inputs along with other representations computed from new data obtained during a task execution phase.

14. The system of claim 1, wherein classifiers and estimators for the different tasks are learned jointly by combining loss functions for different tasks.

15. The system of claim 1, wherein classifiers and estimators for different tasks are learned separately.

16. The system of claim 1, wherein no user or object specific data is uploaded to the cloud and the multimodal identifications are learned and stored in the user device.

17. A system for universal always-on multimodal identification of people and things comprising:
a network interface;
memory;
a camera for capturing image data from one of the people and things;
a microphone for capturing audio data from one of the people and things; and
a processor, wherein the processor receives task-specific representation models for identifying the people and things via the network interface and stores the task-specific representation models in the memory and wherein the processor determines an identity of the one of the people and things using at least one of the captured image data and captured audio data and using the task-specific representation models without sending the captured image data or audio data over the network interface.

18. The system of claim 17, wherein the processor comprises a classifier for determining the identity of the one of the people and things using at least one of the captured image data and captured audio data and using the universal representation model and task-specific representation models.

19. The system of claim 17, wherein the processor determines the identity of the one of the people and things using both the captured image data and the captured audio data.

20. The system of claim 19, further comprising a plurality of sensors for capturing data about the one of the people and things, and wherein the processor determines the identity of the one of the people and things using the captured data from the plurality of sensors.
